(19) United States
(12) Patent Application Publication
(10) Pub. No.: US 2011/0261188 A1
(43) Pub. Date: Oct. 27, 2011

(54) SYSTEM FOR PROVIDING NIGHT VISION AT LOW VISIBILITY CONDITIONS

(76) Inventor: Alberto ADARVE LOZANO, Madrid (ES)

(21) Appl. No.: 12/832,731

(22) Filed: Jul. 8, 2010

(30) Foreign Application Priority Data
Apr. 23, 2010 (ES) 201030598

(51) Int. Cl. H04N 7/18

(52) U.S. Cl. 348/122; 348/E07.085

(57) ABSTRACT

System for providing an enhanced night vision of an scenario from an observation place, such as a system for providing an enhanced night vision of the scenario (15) of an aerial refuelling operation to the tanker aircraft (11), the system operating at night under low visibility conditions due to atmospheric perturbations such as fog, rain and particles in suspension, the system comprising: a) Laser based infrared illumination means (33) of the scenario located in said observation place; b) A black-and-white high-definition imaging system comprising at least a high resolution camera (31) suitable for providing video signals of said scenario when it is illuminated by said illumination means and at least a monitor for displaying images of said scenario.

### FIELD OF THE INVENTION

The present invention relates to a system for providing night vision of an scenario from an observation place at low visibility conditions due to atmospheric perturbations and in particular to a system for providing night vision to moving vehicles.

### BACKGROUND

As it is well known the quality of the images provided by night vision systems decrease when the field of vision is affected by atmospheric perturbations such as fog, rain or particles in suspension which interfere with the propagation of the rays of light used by the vision means.

One known approach to improve the quality of said images combines the use of certain illumination means with certain imaging systems.

As an example of this approach in the aeronautical field, U.S. Pat. No. 6,028,624 discloses an active hyperstereo imaging system comprising an illuminating source, such as a helium-neon laser, and imaging cameras equipped with narrowband filters to provide the pilot with an improved stereo image of a landing environment under fog conditions as an additional means to the radar means that do not have enough spatial resolution to allow a safe landing.

Regarding the illuminating means, there are illuminating means for night vision systems well known in the art such as IR (Infrared Light) means due to the evident advantages that non visible light provides at certain critical situations. To achieve this purpose different types of illuminators have been proposed inside this IR band, from incandescent bulbs filtered with IR pass filters, LED (Light Emitting Diode) based illuminators and recently laser based ones.

However the known night vision systems produce blurred images when the field of vision is affected by atmospheric perturbations such as fog, rain or particles in suspension.

This invention is intended to the solution of this problem.

### SUMMARY OF THE INVENTION

One object of the present invention is a system allowing an enhanced night vision of an scenario from one observation place in low visibility conditions due to fog, rain, particles in suspension or any other atmospheric perturbation.

Another object of the present invention is a system allowing an enhanced night vision of the refuelling scenario in aerial refuelling operations between a tanker aircraft and a receiver aircraft in low visibility conditions due to fog, rain, particles in suspension or any other atmospheric perturbation.

These and other objects are met by a system for providing an enhanced night vision of an scenario from an observation place, the system operating at night under low visibility conditions due to atmospheric perturbations such as fog, rain, or particles in suspension and comprising: a) laser based infrared illumination means of said scenario located in said observation place; b) a black-and-white high-definition imaging system comprising at least a high resolution camera suitable for providing video signals of said scenario when it is illuminated by said illumination means and at least a monitor for displaying images of said scenario.

In a preferred embodiment said observation place is a moving vehicle and said scenario is an outer scenario. Hereby it is achieved an useful system for driving the vehicle in low visibility conditions.

In another preferred embodiment, said moving vehicle is a flying tanker aircraft and said scenario is the refuelling scenario in an aerial refuelling operation. Hereby it is achieved an useful system for performing an operation that in occasions shall take place in said low visibility conditions.

In another preferred embodiment, said moving vehicle is a flying aircraft and said scenario is the scenario available to the aircraft pilot through the cabin windshield. Hereby it is achieved a particular useful system for the aircraft landing operation in said low visibility conditions.

In preferred embodiments, the nominal wavelength of the light emitted by said illumination means is comprised in the range 750-1400 nm and the resolution of said high-definition system is at least of 1280×720 pixels and, preferably, at least of 1920×1080 pixels. Hereby it is achieved an enhanced night vision system under low visibility conditions that can be implemented with available devices.

Other features and advantages of the present invention will be understood from the following detailed description in relation with the enclosed drawings.

### BRIEF DESCRIPTION OF DRAWINGS

FIG. 1 is a schematic view of night vision system for a refuelling operation between a tanker aircraft and a receiver aircraft in low visibility conditions.

FIG. 2 is a schematic view of night vision system for a landing operation of an aircraft in low visibility conditions.

### DETAILED DESCRIPTION OF PREFERRED EMBODIMENTS

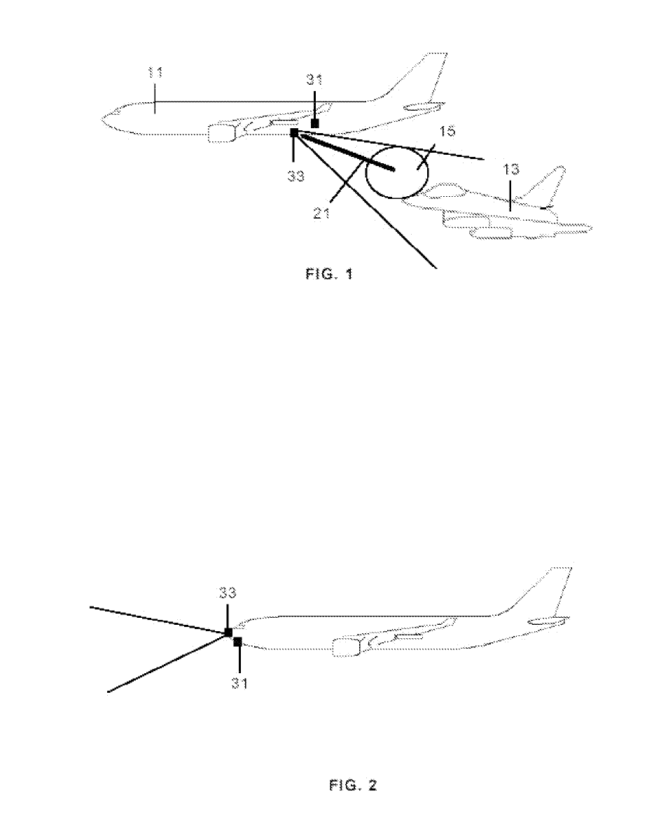

A preferred embodiment of this invention will be described in connection with a system providing an enhanced vision of the refueling scenario in aerial refueling operations from the tanker aircraft which is the subject of a co-pending application, because the subject matter of this invention was found by the inventor when developing the invention of said co-pending application. Then, for a better understanding of the present invention, a brief description of the system of said co-pending application follows in reference to FIG. 1.

For in-flight refuelling operations, one usual method is based on the use of a boom device 21 for interconnecting a tanker aircraft 11 with a receptor aircraft 13 in flight, which is basically a telescopic or extensible tube attached to the under side of the tanker aircraft by means of an articulation element, that provides fuel passage from the tanker aircraft 11 to the receiver aircraft 13. At the tanker aircraft 11, the operator controls visually all steps and procedures for a safe refuelling operation. From the tanker, the operator controls the boom 21 movements and therefore manipulates the boom 21 until it makes a physical connection with the receptacle of the approaching receptor aircraft.

As illustrated in FIG. 1 the vision system comprises:
Laser based infrared illumination means 33 of the refuelling scenario 15 located in the tanker aircraft 11.
An imaging system comprising:
   Vision means 31 located in the lower part of the fuselage of the tanker aircraft 11 that provide both images for stereo monitoring of the refuelling scenario and panoramic images with a permanent overview of the surroundings of the tanker aircraft 11 for situational awareness. The vision means 33 comprises at least two panoramic cameras and at least two high resolution cameras.
   Monitoring means (not shown in FIG. 1) for displaying images taken from said cameras installed in consoles for the Air Refuelling Operator (ARO) and the Mission Coordinator (MC). These two crewmembers are provided with images of the refuelling operations.

When developing the system subject of the said co-pending application several illumination means and several imaging systems were tested and it was found the surprising effect that the combination of a black-and-white high-definition imaging system with laser infrared light produce improved images when the field of vision at night is affected by atmospheric perturbations such as fog, rain or particles in suspension.

One key element of the present invention is indeed the use of a laser infrared light, which is a coherent infrared light suitable for a good penetration in an atmospheric environment affected by fog, rain or particles in suspension, but it shall be noted that if the imaging system is a low-resolution system there is no difference between using laser infrared light or using a non-coherent infrared light. It is the combination of a high-definition imaging systems with laser infrared light which allows improving the quality of the images.

In general terms, a night vision system of an scenario in low visibility conditions due to atmospheric perturbations from an observation place according to the present invention comprises:

a) Laser based infrared illumination means 33 of the scenario located in said observation place.

b) A black-and-white high-definition imaging system comprising at least a high resolution camera 31 suitable for providing video signals of said scenario when it is illuminated by said illumination means and at least a monitor for displaying images of said scenario.

The imaging system can be both a 2D and a 3D imaging system.

Apart from the above-mentioned application for tanker aircrafts, the invention can be also applicable for providing landing aids in low visibility conditions to commercial aircrafts where, as illustrated in FIG. 2, the illuminating means 33 and the high definition camera 31 will be placed on the front part of the aircraft to provide images of an scenario in the field of vision of the aircraft pilot.

It is also conceivable the application of the invention to other moving vehicles in low visibility conditions.

In this invention it is considered a high-definition imaging system a system involving display resolutions of 1280×720 pixels, 1920×1080 pixels or higher resolutions. The cameras shall have at least a black and white scanning sensor at said resolution and have a good sensitivity to the laser infrared light being used, which, preferably is comprised in the range 750-1400 nm.

Although the present invention has been fully described in connection with preferred embodiments, it is evident that modifications may be introduced within the scope thereof, not considering this as limited by these embodiments, but by the contents of the following claims.

1. System for providing an enhanced night vision of an scenario from an observation place, the system operating at night under low visibility conditions due to atmospheric perturbations and comprising:
a) Laser based infrared illumination means (33) of the scenario located in said observation place;
b) A black-and-white high-definition imaging system comprising at least a high resolution camera (31) suitable for providing video signals of said scenario when it is illuminated by said illumination means (33) and at least a monitor for displaying images of said scenario.

2. System according to claim 1, wherein said observation place is a moving vehicle and said scenario is an outer scenario.

3. System according to claim 2, wherein said moving vehicle is a flying tanker aircraft (11) and said scenario is the refuelling scenario (15) in an aerial refuelling operation.

4. System according to claim 2, wherein said moving vehicle is a flying aircraft and said scenario is the scenario available to the aircraft pilot through the cabin windshield.

5. System according to claim 1, wherein said atmospheric perturbations comprise one or more of the following: fog, rain, particles in suspension.

6. System according to claim 1, wherein the nominal wavelength of the light emitted by said illumination means (33) is comprised in the range 750-1400 nm.

7. System according to claim 1, wherein the resolution of said high-definition system is at least of 1280×720 pixels.

8. System according to claim 7, wherein the resolution of said high-definition system is at least of 1920×1080 pixels.

9. System according to claim 2, wherein said atmospheric perturbations comprise one or more of the following: fog, rain, particles in suspension.

10. System according to claim 3, wherein said atmospheric perturbations comprise one or more of the following: fog, rain, particles in suspension.

11. System according to claim 4, wherein said atmospheric perturbations comprise one or more of the following: fog, rain, particles in suspension.

12. System according to claim 2, wherein the nominal wavelength of the light emitted by said illumination means (33) is comprised in the range 750-1400 nm.

13. System according to claim 3, wherein the nominal wavelength of the light emitted by said illumination means (33) is comprised in the range 750-1400 nm.

14. System according to claim 4, wherein the nominal wavelength of the light emitted by said illumination means (33) is comprised in the range 750-1400 nm.

15. System according to claim 5, wherein the nominal wavelength of the light emitted by said illumination means (33) is comprised in the range 750-1400 nm.

16. System according to claim 2, wherein the resolution of said high-definition system is at least of 1280×720 pixels.

17. System according to claim 3, wherein the resolution of said high-definition system is at least of 1280×720 pixels.

18. System according to claim 4, wherein the resolution of said high-definition system is at least of 1280×720 pixels.

19. System according to claim 5, wherein the resolution of said high-definition system is at least of 1280×720 pixels.

20. System according to claim 6, wherein the resolution of said high-definition system is at least of 1280×720 pixels.
